(19) United States
(12) Patent Application Publication
(10) Pub. No.: US 2005/0257039 A1
(43) Pub. Date: Nov. 17, 2005

(54) Virtual private network configuration system and method

(75) Inventor: Hamid Marshall, San Jose, CA (US)

Correspondence Address: WILSON SONSINI GOODRICH & ROSATI, 650 PAGE MILL ROAD, PALO ALTO, CA, 94304-1050, US

(73) Assignee: Netgear, Inc., Santa Clara, CA (US)

(21) Appl. No.: 10/845,770

(22) Filed: May 13, 2004

(51) Int. Cl. G06F 15/177

(52) U.S. Cl. 713/1

(57) ABSTRACT

Method for configuring a tunnel connection between a first gateway and second gateway. Configuration of the tunnel connection is completed at the first gateway in response to a user request. At the second gateway, a request is received from the user to configure the second gateway, and an identification of the first gateway is received from the user. A request for configuration information is sent from the second gateway to the first gateway. The first gateway authenticates the second gateway based on information received from the second gateway. The second gateway sends configuration information to the first gateway, and the second gateway is automatically configured, based on the configuration information received from the first gateway. Also described is a method of configuring an IPSec connection between a first gateway and a second gateway. Additionally a network system is described, which includes a first gateway, second gateway and logic to establish a tunnel connection.

### BACKGROUND OF THE INVENTION

This invention is related to Internet security software applications. The disclosure particularly describes systems and methods configuration of gateways for a virtual private network.

A virtual private network (VPN) is a shared network where private data is segmented from other traffic so that only the intended recipient has access. The term virtual private network was originally used to describe a secure connection over the Internet. Today, however, virtual private network is also used to describe private networks, such as Frame Relay, Asynchronous Transfer Mode (ATM), and Multiprotocol Label Switching (MPLS).

A key aspect of data security is that the data flowing across the network is protected by encryption technologies. Public networks lack data security, which allows data attackers to tap directly into the network and read the data. IPSec-based virtual private networks use encryption to provide data security, which increases the network's resistance to data tampering or theft.

IPSec-based virtual private networks can be created over various types of IP networks, including the Internet, Frame Relay, ATM, and MPLS.

Virtual private networks are traditionally used for:
Intranets: Intranets connect an organization's locations.
Remote Access: Remote access enables telecommuters and mobile workers to access e-mail and business applications.
Extranets: Extranets are secure connections between two or more organizations.

IPSec is an Internet Engineering Task Force (IETF) standard suite of protocols that provides data authentication, integrity, and confidentiality as data is transferred between communication points across IP networks. IPSec provides data security at the IP packet level. A packet is a data bundle that is organized for transmission across a network, and includes a header and payload (the data in the packet). IPSec is designed to protect against possible security exposures by protecting data while in transit.

IPSec was designed to provide the following security features when transferring packets across networks:
Authentication: Verifies that the packet received is actually from the claimed sender.
Integrity: Ensures that the contents of the packet did not change in transit.
Confidentiality: Conceals the message content through encryption.
IPSec contains the following elements:
Encapsulating Security Payload (ESP): Provides confidentiality, authentication, and integrity.
Authentication Header (AH): Provides authentication and integrity.
Internet Key Exchange (IKE): Provides key management and Security Association (SA) management.

IPSec introduces the concept of the security association (SA). A security association is a logical connection between two devices transferring data. A security association provides data protection for unidirectional traffic by using the defined IPSec protocols. An IPSec tunnel typically consists of two unidirectional security associations, which together provide a protected, full-duplex data channel.

The security associations allow an enterprise to control exactly what resources may communicate securely, according to security policy. To do this, an enterprise can set up multiple security associations to enable multiple secure virtual private networks, as well as define security associations within the virtual private network to support different departments and business partners.

In most cases, each virtual private network gateway will have a “public” facing address (WAN side) and a “private” facing address (LAN side). These addresses are referred to as the “network interface” in documentation regarding the construction of virtual private network communication.

A security association, frequently called a tunnel, is the set of information that allows two entities (networks, PCs, routers, firewalls, gateways) to “trust each other” and communicate securely as they pass information over the Internet.

The security association contains the information for gateway A to negotiate a secure and encrypted communication stream with gateway B. This communication is often referred to as a “tunnel.” The gateways contain this information so that it does not have to be loaded onto every computer connected to the gateways.

Configuration of virtual private network systems is usually complicated and cumbersome. For example, this process can involve configuration of IKE policy and the virtual private network policy at a local gateway and at a remote gateway. The process is subject to error and involves costly administrator time. Therefore, improved technologies and methods related to such configuration are desirable.

### SUMMARY

An embodiment of the invention is directed to a method of configuring a tunnel connection between a first gateway and a second gateway. Configuration of the tunnel connection is completed at the first gateway in response to a user request. At the second gateway, a request is received from the user to configure the second gateway, and an identification of the first gateway is received from the user. A request for configuration information is sent from the second gateway to the first gateway. The first gateway authenticates the second gateway based on information received from the second gateway. The second gateway sends configuration information to the first gateway, and the second gateway is automatically configured, based on the configuration information received from the first gateway.

According to an embodiment of the invention, the second gateway sends a hardware address of the second gateway to the first gateway, and the authenticating of the second gateway is based on the hardware address. The authenticating comprises determining whether the hardware address is within a particular range of addresses. The authenticating may also comprise testing the hardware address using a lookup table. The authenticating may also comprise determining whether the hardware address is one associated with a particular vendor.

According to an embodiment of the invention, tunnel policy information is received from a user for configuration database of the first gateway. According to another embodiment of the invention, the user is presented with default suggestions for configuration of the first gateway.

The identification of the first gateway received from the user may include public and private addresses of the first gateway. According to an embodiment of the invention, the identification of the first gateway received from the user comprises an IP address. The identification of the first gateway received from the user may also comprise a fully qualified domain name (FQDN).

An embodiment of the invention is directed to a method of configuring an IPSec tunnel connection between a first gateway and a second gateway. A remote user login is accommodated at the first gateway. The selection or entry of the configuration information from the user is received at the first gateway, and the configuration of the IPSec tunnel connection is completed at the first gateway in response to a user request. A remote user login is accommodated at the second gateway, and at the second gateway, a request is received from the user to configure the second gateway. At the second gateway, an address or FQDN of the first gateway is received from the user, and request for configuration information is sent from the second gateway to the first gateway. The first gateway authenticates the second gateway based on an address that the first gateway received from the second gateway. If the authentication is successfull, the first gateway sends configuration information to the second gateway. The IPSec tunnel connection is configured automatically on the second gateway, based on the configuration information received from the first gateway.

According to an embodiment of the invention, the user may be presented with suggested configuration information for configuration of the first gateway including an authentication algorithm. The user may be presented with suggested configuration information for configuration of the first gateway including a security association (SA) lifetime. The user may also be presented with suggested configuration information for configuration of the first gateway includes a security association (SA) tunnel size. The user may be presented with suggested configuration information for configuration of the first gateway including authentication mode, and/or traffic selector mode.

According to an embodiment of the invention, the second gateway sends the first gateway an acceptance message after receipt of the configuration information from the first gateway. The second gateway sends a ping to the second gateway, according to an embodiment of the invention, and the second gateway sends the user an acknowledgement that the tunnel has been established after receipt of the ping message from the first gateway.

Another embodiment of the invention is directed to a network system. Included in the network system is a first gateway, a second gateway and logic to establish a tunnel connection. Included is logic that completes configuration of the tunnel connection at the first gateway in response to a user request, and logic in the second gateway that receives a request from the user to configure the second gateway. Logic in the second gateway receives an identification of the first gateway from the user, and logic sends a request for configuration information from the second gateway to the first gateway. Logic in the first gateway authenticates the second gateway based on information received from the second gateway. Logic in the second gateway sends configuration information to the first gateway, and logic in the system automatically configures the second gateway, based on the configuration information received from the first gateway.

Another embodiment of the invention is directed to a network system including a first local network including a plurality of hosts and a first gateway and a second local network including a second plurality of hosts and a second gateway. Also included is logic to establish an IPSec tunnel connection between the first gateway and the second gateway.

Another embodiment of the invention is directed to a computer program for configuring an IPSec tunnel between a first gateway and a second gateway. The computer program includes computer-readable code, the computer-readable code including:
HTML code;
code on the second gateway that accommodates a remote user login;
code on the second gateway that receives a request from the user to configure the second gateway;
code on the second gateway that receives a reference to the first gateway;
code that sends a request for configuration information from the second gateway to the first gateway;
code that authenticates the second gateway based on an address of the second gateway;
code that sends configuration information to the first gateway; and
code that automatically configures the IPSec tunnel connection on the second gateway, based on the configuration information received from the first gateway.

According to an embodiment of the invention, the computer-readable code includes:
code that accommodates a remote user login on the first gateway;
code that receives selection or entry of configuration information from the user at the first gateway; and
code that completes configuration of the IPSec tunnel connection at the first gateway in response to a user request.

Another embodiment of the invention is directed to a business method. According to the business method, configuration software is provided for configuring an IPSec tunnel connection between a first gateway and a second gateway. The configuration software includes code that
receives a request from the user to configure the second gateway;
receives an identification of the first gateway from the user;
causes the second gateway to send a request for configuration information to the first gateway;
determines whether the second gateway is within a particular set of gateways based on a test; and
if the test is passed, causes the second gateway to send configuration information to the first gateway.

According to an embodiment of the invention, the test identifies gateways provided by a single vendor. The test may alternatively identify gateways provided by a selected plurality of vendors. The test may use a lookup table to determine whether the address of the second gateway is an address of a gateway provided by an approved vendor. Also, the test may determine whether a MAC address of the second gateway is a MAC address of a particular set of gateways.

According to an embodiment of the invention, gateways are provided having hardware addresses capable of identification by the test.

### BRIEF DESCRIPTION OF THE DRAWINGS

FIG. 1 shows a virtual private network with an administrator, according to an embodiment of the invention.

FIG. 2 is a flow diagram of configuration of a virtual private network, according to an embodiment of the invention.

FIG. 3 is a communication flow diagram of configuration of a virtual private network, according to an embodiment of the invention.

FIG. 4 is a series of schematics showing aspects of user interface screens for automatic configuration of a second gateway, according to an embodiment of the invention.

FIG. 5 is a schematic of a user interface screen for entering information regarding a virtual private network, according to an embodiment of the invention.

### DETAILED DESCRIPTION

An embodiment of the invention is directed to a system for configuring gateways of a virtual private network tunnel. A virtual private network tunnel allows for secure communication between two systems, such as between two LANs. The tunnel establishes communication between gateways connected to each of the respective systems.

For example, the two systems may comprise two LANs, LAN A and LAN B, between which communication is to be established. A gateway is coupled to each LAN, and the virtual private network tunnel is established between the two gateways. In this example, gateway A may be coupled to LAN A, and gateway B may be coupled to LAN B, and the virtual private network tunnel is established between gateway A and gateway B.

First, one of the gateways is configured, for example, gateway A. This gateway may be known as the anchor or host gateway. Next, the other gateway, for example, gateway B, is automatically configured and provisioned based on the configuration of the first gateway. The second gateway may be known as the remote gateway.

The anchor gateway establishes a secure connection via secure sockets layer (SSL protocol to the remote gateway. The system provides an automatic message exchange and challenge and after the authentication when the connection is established, the configuration data is pushed to the remote gateway. An embodiment of the invention is directed to configuration between the client PC and a gateway where the anchor gateway pushes the configuration data to the client PC.

This involves configuration of IKE policy and the virtual private network policy at a local gateway and at a remote gateway. According to one embodiment, a sequence of HTML pages is provided to configure the virtual private network subsystem. An automated remote configuration system is provided which enables a network administrator to log in to a remote gateway and have the gateway download the virtual private network configuration information from a local gateway which has already been configured. According to an embodiment, the gateway pushes or receives the configuration information to the remote clients.

After creating the policies through this system, the user can later update the parameters, for example, through a virtual private network settings link on a user interface menu provided by the system.

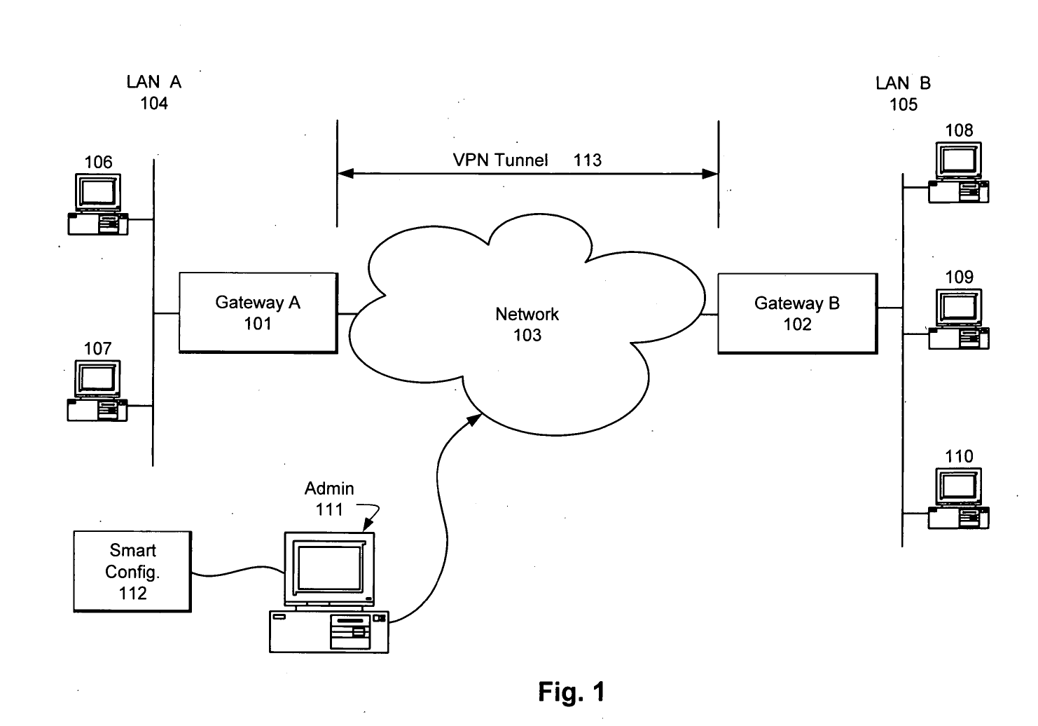

FIG. 1 shows a virtual private network with an administrator, according to an embodiment of the invention. Shown in FIG. 1 are gateway A 101, gateway B 102, network 103, LAN A 104, and LAN B 105. LAN A 104 includes host 106 and host 107. LAN B 105 includes host 108, host 109 and host 110. FIG. 1 also includes administrator terminal 111 and smart configuration application 112. Also shown is VPN tunnel 113.

Gateway A 101 and gateway B 102 are coupled by network 103. Network 103 may comprise the Internet, or other public network. According to various embodiments, network 103 may comprise various types of IP networks, including the Internet, frame relay, ATM, and MPLS. Host 106, host 107 and gateway A 101 are coupled to LAN A 104. Host 108, host 109, host 110 and gateway B 102 are coupled to LAN B 105. LAN A 104 and LAN B 105 may each comprise an Ethernet LAN, or other type of network. According to alternative embodiments, one or both of the gateways are coupled to other entities other than LANs, such as PCs.

Administrator terminal 111 includes smart configuration application 112 and is coupled to other aspects of the system, for example, through network 103. Virtual private network tunnel 113 runs through network 103 between gateway A 101 and gateway B 102.

A virtual private network tunnel 113 is set up between gateway A 101 and gateway B 102. To set up the tunnel between the gateways, the tunnel is configured on each gateway. First, one of the gateways is configured, such as gateway A 101. A user logs onto gateway A 101 via a remote terminal such as administrator terminal 111. Gateway A 101 is configured with the virtual private network policy so that a virtual private network may be eventually established with another to include other devices through another gateway, such as gateway B 102. Administrator terminal 111 receives a number of pieces of information which constitute the policy information for the virtual private network tunnel. At this point, gateway A 101 has been configured for a virtual private network.

Next, the other gateway, for example, gateway B 102, is configured automatically, based on information from the first gateway. The user logs onto gateway B 102 via administrator terminal 111. Smart configuration application 112 is used to automatically configure gateway B 102 for the virtual private network tunnel communication with gateway A 101. Smart configuration application 112 receives an identification of gateway A 101, such as the address of gateway A 101. Then, smart configuration application 112 automatically configures gateway B 102 to implement the virtual private network tunnel with gateway A 101, by obtaining the policy information from gateway A 101.

Before the policy information is transmitted from gateway A 101 to gateway B 102 to configure gateway B 102, gateway A 101 authenticates the request from gateway B 102. Such authentication, according to an embodiment of the invention, is based on gateway A 101 determining whether the address, such as a hardware address, of gateway B 102 meets a particular test. For example, gateway A 101 may determine whether gateway B 102's hardware address fits within a particular range of address, such as the addresses of a particular hardware vendor or set of vendors.

After such authentication has been completed, additional checking may be performed, such as a ping to verify that the virtual private network tunnel has been established. The smart configuration application 112 on administrator terminal 111 then receives a confirmation that the virtual private network has been established. Smart configuration application 112 may then acknowledge to the user that the virtual private network tunnel 113 has been established. Then, communication may take place between LAN A 104 and LAN B 105 via a virtual private network tunnel between gateway A 101 and gateway B 102. Such virtual private network tunnel allows for secure communication between members of LAN A 104 and LAN B 105 through a network 103.

The configuration of the first gateway and the second gateway is performed by computer readable software code, according to an embodiment of the invention. Such code is located in part on different portions of the elements shown in its description. For example, portions of the code may be implemented in gateway A 101, gateway B 102 and administrator terminal 111.

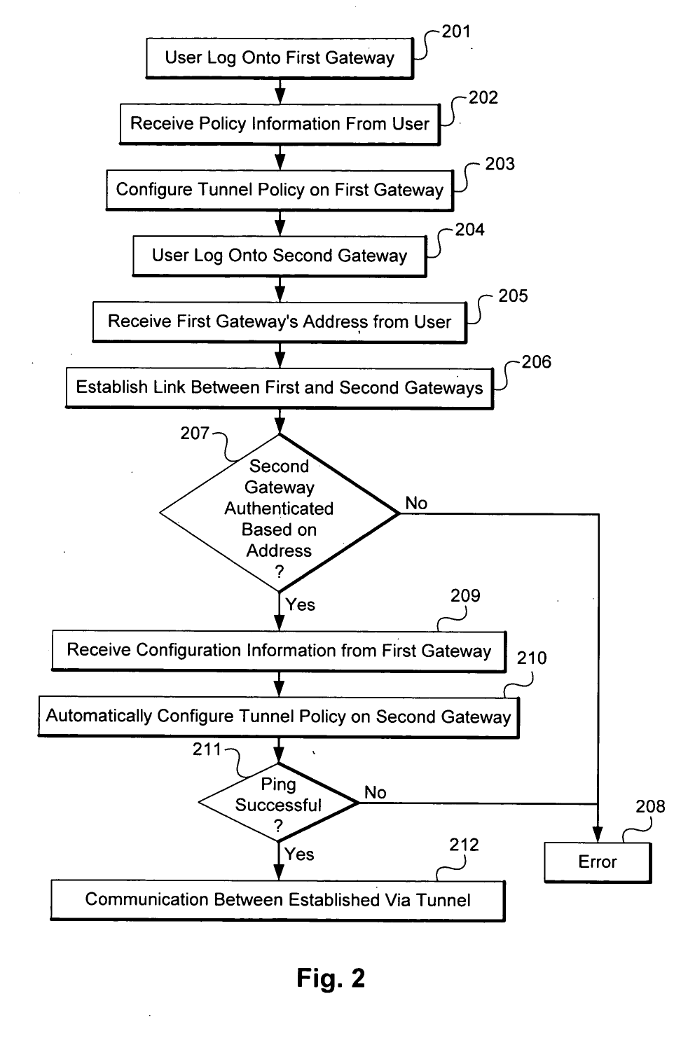

FIG. 2 is a flow diagram of configuration of a virtual private network, according to an embodiment of the invention. A user remotely configures a first to second gateway, and the system automatically configures the second gateway for the virtual private network based on information from the first gateway. The process involves the second gateway being authenticated before the second gateway is configured. Such authentication may be based on checking an address of the second gateway.

First, the user logs onto the first gateway (block 201). The first gateway receives policy information from the user (block 202). The policy information is received from the user entering respective data for the policy on a user interface at an administrator terminal. The policy information is information for the virtual private network tunnel such that the first gateway can be an end of the virtual private network tunnel. The tunnel policy is configured on the first gateway based on the policy information received from the user (block 203).

Next, the user logs onto a second gateway that will communicate via the virtual private network tunnel (block 204). Some information is received from the user to identify the first gateway so that the virtual private network tunnel may be established with the first gateway. For example, the first gateway's address is received from the user (block 205).

A link is then established between the first and second gateways (block 206). This link is not the establishment of a fully configured and operating virtual private network tunnel between the first and second gateways, but is rather a link that is used in the establishment of the tunnel.

Authentication is performed on the second gateway (block 207). Such authentication is based, according to an embodiment of the invention, or determining whether the address of the second gateway, such as the hardware MAC address of the second gateway, meets a particular test. For example, according to one embodiment of the invention, it is determined whether the MAC address of the second gateway is an address issued by a particular manufacturer, such as the manufacturer of the first gateway. This test may be performed by determining whether the address is within a particular range or particular ranges of addresses. The test as to whether the address is in a particular range or ranges of addresses is performed, according to an embodiment in the invention, based on a lookup table. Such lookup table may include valid addresses for which the test would be passed. If such authentication is not successful, an error state is entered (block 208). If such authentication is successful, the configuration process is continued, and configuration information is received from the first gateway (block 209).

The tunnel policy for the virtual private network tunnel between the first and second gateways is automatically configured on the second gateway based on the configuration information received from the first gateway (block 210). A test of the virtual private network tunnel may be performed, such as a ping test (block 211). If such ping test is not successful, then an error state is entered. If such ping test is successful (block 211), then communication may take place between the respective networks via the virtual private network tunnel that has been established (block 212).

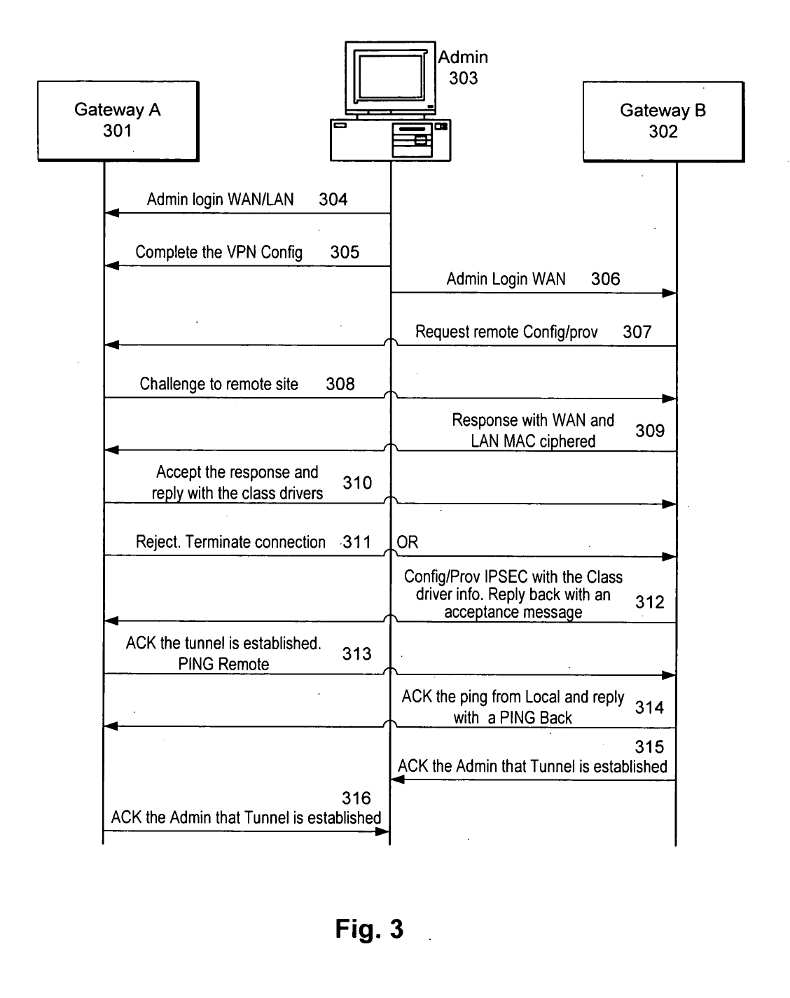

FIG. 3 is a communication flow diagram of configuration of a virtual private network, according to an embodiment of the invention. Shown in FIG. 3 are gateway A 301, gateway B 302 and administration terminal 303. A virtual private network tunnel is configured and established between gateway A 301 and gateway B 302. Administration terminal 303 is shown between gateway A 301 and gateway B 302 for convenience of illustration; but administration terminal 303 may be located elsewhere such that it can communicate with gateway A 301 and gateway B 302. FIG. 3 shows administration terminal 303 communicating with gateway A 301 and gateway B 302 in order to configure such gateways. FIG. 3 shows communication that takes place between gateway A 301 and gateway B 302 as part of the configuration of the virtual private network tunnel between them.

The administrator application 303 logs into gateway A 301 through a WAN or LAN connections (line 304). The virtual private network tunnel is configured on gateway A 301 (line 305). Such configuration of gateway A 301 may involve the user entering the configuration information into a user interface.

Next, the administrator logs onto gateway B 302, for example, through a remote connection such as through a WAN (line 306). The system kicks off a configuration process for gateway B 302 to be configured with the virtual private network tunnel configuration (line 307). In order to initiate configuration of a tunnel starting with gateway A, the user may provide administration application 303 with an identification of gateway A 301. Such identification of gateway A 301 may comprise the address of gateway A 301.

Gateway B 302 automatically requests configuration information for the virtual private network tunnel from gateway A 301 (line 307) over a secure network. Before responding with the configuration information, an authentication process to authenticate gateway B 302 is initiated. This authentication includes a challenge to remote site (line 308). Gateway B 302 responds to the challenge, providing specific information that will be tested by gateway A 301 for authentication purposes (line 309). For example, here gateway B 302 responds with a WAN and LAN MAC address, which is ciphered (line 309). A test is performed on the provided information at gateway A 301. If the test is passed, the response is accepted, and gateway A 301 replies with class drivers in order to facilitate the automatic configuration of gateway B 302 (line 310). Alternatively, if the test is failed, the request for configuration information is rejected and the connection is terminated (line 311).

Assuming that the response has been accepted, gateway B 302 can then be configured automatically for the virtual private network tunnel, by configuring IPSec with the class driver information that was provided by gateway A 301. After the configuration, gateway B 302 replies to gateway A 301 with an acceptance message (line 312).

Having received such acceptance message, gateway A 301 responds with a acknowledgement that the tunnel has been established and pings the remote gateway B 302 (line 313). In response to the ping, gateway B 302 acknowledges the ping and replies with a ping back to gateway A 301 (line 314). Gateway B 302 acknowledges to the administration application that the virtual private network tunnel has been established (line 315). In response to the ping from gateway B 302, gateway A 301 also acknowledges to the administration application that the virtual private network tunnel has been established (line 316).

Thus, at this point a virtual private network tunnel is established between gateway A 301 and gateway B 302. Secure communication can then take place in a virtual private network that includes gateway A 301 and gateway B 302 by way of the tunnel established between these gateways.

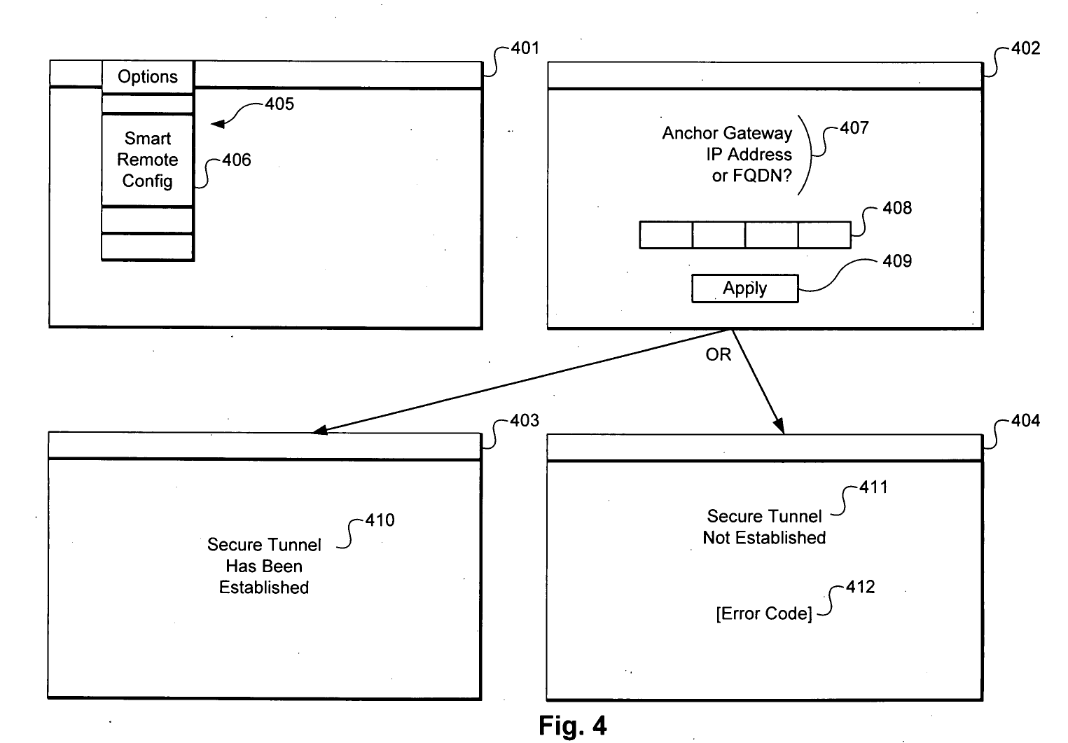

FIG. 4 is a series of schematics showing aspects of user interface screens for automatic configuration of a second gateway, according to an embodiment of the invention. The user is presented with the opportunity to automatically configure the second gateway as part of the virtual private network that has been configured on the first gateway. The user requests such configuration of the second gateway by way of the user interface, and the user is prompted for certain information regarding the first gateway via the user interface. The second gateway is then automatically configured based on information received from the first gateway.

Shown in FIG. 4 are pull down menu screen 401, anchor gateway identification screen 402, success screen 403 and failure screen 404. According to an embodiment of the invention, the screens shown comprise a sequence of HTML pages. First, the user requests automatic configuration of the second gateway in configuration screen 401. This takes place via a pull down menu 405, according to an embodiment of the invention. An option 406 for automatic configuration of the second gateway is provided on pull down menu 405.

Next, the user is prompted to provide an identification of the first gateway in user input screen 402. In an embodiment of the invention, the user is prompted to provide an address of the first gateway, such as an IP address or an FQDN address. Such prompt is shown as item 407 of screen 402. A dialog box 408 is provided to allow the user to enter the information regarding the first gateway, such as the address of the first gateway. The user interface provides a box or other entry mechanism such as apply box 409 by which the user can then initiate automatic configuration of the second gateway. Next, depending on whether the automatic configuration of the second gateway has been successful, success screen 403 or failure screen 404 are displayed respectively.

Success screen 403 has a message 410 which indicates that the secure tunnel has been established. Failure screen 404 provides a message 411 that the secure tunnel has not been established as well as an error code 412. Such success or failure depends on the process of automatic configuration which can provide automatic authentication of the second gateway, such as by testing the address of the second gateway at the first gateway to determine whether the address is within a particular range of addresses. According to an embodiment of the invention, the second gateway is configured automatically based on a single click received from the user after the user has provided an identification of the first gateway.

Certain assumptions may be made, according to various embodiments of the invention, during the configuration process. According to one embodiment, configuration of the virtual private network is made using standard recommendations for configuration of various parts of the virtual private network. This is made with respect to both IKE and VPN policies. These assumptions are made to configure items within the configuration of the first gateway. Then, they are used in automatic configuration of the second gateway. According to an embodiment of the invention, the user can edit these assumed configurations; however, they are provided as optional default values that the user may accept.

Following is more information regarding the configuration of a virtual private network tunnel according to an embodiment of the invention.

To set up a virtual private network connection, each endpoint is configured with specific identification and connection information describing the other endpoint. The outbound virtual private network settings on one end are configured to match the inbound virtual private network settings on other end, and vice versa.

This set of configuration information defines a security association (SA) between the two points. According to an embodiment of the invention, in the configuration of the first gateway, the system prompts the user to make the following selections regarding the virtual private network:
Whether the local end is any device on the LAN, a portion of the local network (as defined by a subnet or by a range of IP addresses), or a single PC.
Whether the remote end is any device on the remote LAN, a portion of the remote network (as defined by a subnet or by a range of IP addresses), or a single PC.
Whether one side has a fixed IP address or the connection uses a dynamic DNS service for FQDN configurations. Otherwise, if one side has a dynamic IP address, the side with a dynamic IP address is the initiator of the connection.
Will the typical automated Internet Key Exchange (IKE) setup be used, or a Manual Keying setup in which each phase of the connection is specified.
For the WAN connection, what level of IPSec virtual private network encryption will be used:
DES—The Data Encryption Standard (DES) processes input data that is 64 bits wide, encrypting these values using a 56 bit key.
3DES—(Triple DES) achieves a higher level of security by encrypting the data three times using DES with three different, unrelated keys.

The virtual private network tunnel configuration consists of these two kinds of information:
Connection. The connector identifies the virtual private network endpoints by IPSec identifier, IP address, or a fully qualified domain name (FQDN). A FQDN is the complete URL of the router. Using a dynamic DNS service for the gateway with a dynamically-assigned IP address enables the gateway to both initiate and respond to requests to open a virtual private network tunnel. Otherwise, the gateway with a dynamically-assigned IP address can only initiate a request to open a virtual private network tunnel because no other initiators can know its IP address.
Security Association (SA). According to an embodiment of the invention, there are two main kinds of SA key exchange modes that are selected among:
IKE Main Mode: Uses the Internet Key Exchange (IKE) protocol to define the authentication scheme and automatically generate the encryption keys.
IKE Aggressive Mode: Uses the IKE protocol to define the authentication scheme and automatically generate the encryption keys.

Matching virtual private network settings are configured on both virtual private network endpoints. The outbound virtual private network settings on one end match to the inbound virtual private network settings on the other end, and vice versa.

Network parameters are configured for the virtual private network tunnels on these gateways. Note that a gateway may have multiple virtual private network tunnels, and the network parameters are configured for respective virtual private network tunnels. Virtual private network settings include items such as connection name, local IPSec identifier, remote IPSec identifier, tunnel can be accessed from, local LAN start IP address, local LAN finish IP address, local LAN IP subnetmask, tunnel can access, remote LAN start IP address, remote LAN finish IP address, remote LAN IP subnetmask, and remote WAN IP or FQDN.

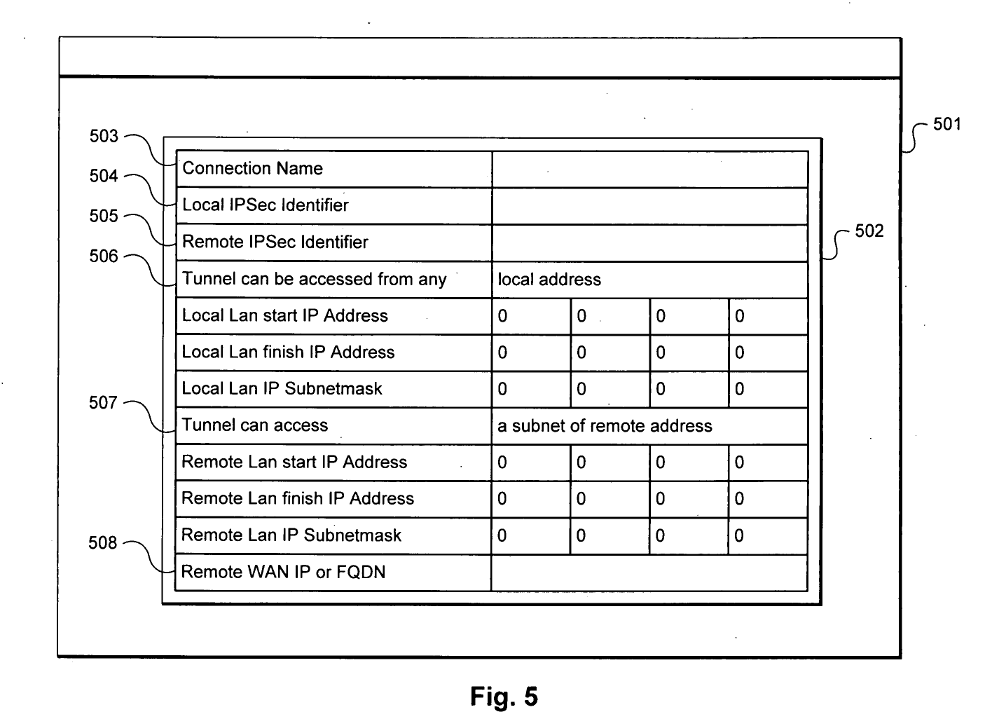

FIG. 5 shows a user interface for entering information regarding the virtual private network tunnel configuration, for example, for the first gateway. The second gateway is automatically configured as described herein, according to an embodiment of the invention. FIG. 5 includes interface window 501 and entry form 502. Entry form 502 includes fields 503-508. The following is additional description of the information entered in the user interface such as the one shown in FIG. 5.

Connection Name 503: The descriptive name of the virtual private network tunnel. Each tunnel can have a unique name. The name helps the user identify virtual private network tunnels.

Local IPSec Identifier 504: A Local IPSec Identifier name for this endpoint. This name is used in configuration of the other virtual private network endpoint as the Remote IPSec Identifier.

Remote IPSec Identifier 505: Enter a Remote IPSec Identifier name for the remote endpoint. This name is used in configuration of the other virtual private network endpoint as the Local IPSec Identifier.

Tunnel can be accessed from 506: This field is used to manage what IP addresses in the LAN can use this virtual private network tunnel. The following options are available according to one embodiment:
1. Any local address: This selection will enable various devices on the LAN to communicate with the designated devices on the remote LAN communications through this tunnel.
2. A subnet of local addresses: Receive the user's entry of the Local LAN start IP address and subnet mask.
3. A range of local addresses, such as members of a department on the LAN: Receive the user's entry of the start and finish Local IP addresses.
4. A single local address, such as a single PC.

Tunnel can access 507: This field is used to manage what IP addresses in the remote connection can use this virtual private network tunnel. The following options are available according to one embodiment:
1. A subnet of remote addresses: Receive the user's entry of a subnet for the remote LAN.
2. A range of remote addresses, such as members of a department: Receive the user's entry of the start and finish Local IP addresses.
3. A single remote address, such as a single PC.
If the PC is connected directly to the Internet, receive the user's entry of the PC's public IP address.
If the PC is connected to the Internet through a NAT router, receive the user's selection “A subnet of remote addresses” and enter the remote PC's LAN IP address in the Remote LAN start IP Address field, along with a Remote LAN IP Subnet Mask of 255.255.255.0. Then receive the user's entry of the NAT router's public (WAN) IP address or FQDN in the Remote WAN IP or FQDN field below.
4. The Remote WAN IP or FQDN: Enables traffic to the target remote virtual private network endpoint PC or virtual private network gateway identified by a WAN IP address or a FQDN. Receive the user's entry of the remote WAN IP address or FQDN.

Remote WAN IP or FQDN 508: Receive the user's entry of the remote WAN IP address or FQDN.

Common configuration scenarios will use IKE to manage the authentication and encryption keys. The IKE protocol performs negotiations between the two virtual private network endpoints to automatically generate required parameters.

The user interface provides the user the opportunity to set up the main mode. The configuration includes: Security Association, Perfect Forward Secrecy, Encryption Protocol, PreShared Key, Key Life, IKE Life Time, and NETBIOS Enable.

The Security Association IKE main mode configuration fields are described in more detail below.

Secure Association: Choose Main Mode key exchange mode for this virtual private network tunnel:
IKE Main Mode—the default.
IKE Aggressive Mode.
Manual Keys.

Perfect Forward Secrecy: Perfect Forward Secrecy provides additional security by means of a shared secret value.

Encryption Protocol: The level of encryption.
Null—Fastest but no security.
DES—The Data Encryption Standard (DES) processes input data that is 64 bits wide, encrypting these values using a 56 bit key.
3DES—(Triple DES) achieves a higher level of security by encrypting the data three times using DES with three different, unrelated keys.

Pre-Shared Key: Specify the key. Any value is acceptable, provided the remote virtual private network endpoint has the same value in its Pre-Shared Key field.

IPSec SA Key Life Time: The default is 86400 seconds (twenty four hours).

IKE Life Time: At the end of this time, the connection will drop, the security association will be re-established, and the connection will be reactivated. The default is 28800 seconds (eight hours).

NETBIOS Enable: Receive user's selection of the NETBIOS Enable check box to allow NETBIOS traffic over the virtual private network tunnel. Enable networking functions such as Microsoft's Network Neighborhood.

Alternatively, the security association may be configured using IKE Aggressive Mode. The user interface provides the user the opportunity to set up the IKE Aggressive Mode. The configuration includes: Security Association, Perfect Forward Security, Encryption Protocol, Key Group, PreShared Key, Key Life, IKE Life Time, and NETBIOS Enable.

The Security Association IKE Aggressive Mode fields are described in more detail below.

Secure Association: Choose Aggressive Mode key exchange mode for this virtual private network tunnel:
IKE Main Mode—the default.
IKE Aggressive Mode.
Manual Keys.

Perfect Forward Secrecy: Perfect Forward Secrecy (PFS) provides additional security by means of a shared secret value.

Encryption Protocol: Level of encryption.
Null—Fastest but no security.
DES—The Data Encryption Standard (DES) processes input data that is 64 bits wide, encrypting these values using a 56 bit key.
3DES—(Triple DES) achieves a higher level of security by encrypting the data three times using DES with three different, unrelated keys.

Key Group: This setting determines the Diffie-Hellman group bit size used in the key exchange. This matches the value used on the remote gateway.

Pre-Shared Key: Receive the user's specification of the key. Any value is acceptable, provided the remote virtual private network endpoint has the same value in its Pre-Shared Key field.

Key Life: The default is 3600 seconds (one hour).

IKE Life Time: At the end of this time, the connection will drop, the security association will be re-established, and the connection will be reactivated. The default is 28800 seconds (eight hours).

NETBIOS Enable: Receive user's selection of the NETBIOS Enable check box to allow NETBIOS traffic over the virtual private network tunnel. Enable networking functions such as Microsoft's Network Neighborhood.

The Manual Keys configuration fields are described in more detail below.

Secure Association: Receive the user's entry of Manual Keys key exchange mode for this virtual private network tunnel:
IKE Main Mode—the default.
IKE Aggressive Mode.
Manual Keys.

Incoming SPI: Incoming Security Parameter Index. Receive the user's entry of a Hex value (3-8 characters). This string should not be used in any other security association. Any value is acceptable, provided the remote virtual private network endpoint has the same value in its “Outgoing SPI” field.

Outgoing SPI: Outgoing Security Parameter Index. Receive the user's entry of a Hex value (3-8 characters). This string should not be used in any other security association. Any value is acceptable, provided the remote virtual private network endpoint has the same value in its “Incoming SPI” field.

Encryption Protocol: The level of encryption to be used.
Null—Fastest but no security.
DES—The Data Encryption Standard (DES) processes input data that is 64 bits wide, encrypting these values using a 56 bit key. Faster but less secure than 3DES or AES.
3DES—(Triple DES) achieves a higher level of security by encrypting the data three times using DES with three different, unrelated keys.

Key Group: This setting determines the Diffie-Hellman group bit size used in the key exchange. This matches the value used on the remote gateway.

Pre-Shared Key: Receive the user's selection of the key. Any value is acceptable, provided the remote virtual private network endpoint has the same value in its Pre-Shared Key field.

Authentication Protocol: Provide this drop-down list to receive user's selection of the authentication protocol:
SHA1—default for a virtual private network automatic configuration wizard Authentication Key: Receive user's entry of the key.
For SHA-1, the key should be 20 characters.

Any value is acceptable, provided the remote virtual private network endpoint has the same value in its Authentication Protocol Key field.

IPSec default Key Life: The default is 86400 seconds (twenty four hours).

IKE Life Time: At the end of this time, the connection will drop, the security association will be re-established, and the connection will be reactivated. The default is 28800 seconds (eight hours).

NETBIOS Enable: Receive user's selection of the NETBIOS Enable check box to allow NETBIOS traffic over the virtual private network tunnel. Enable networking functions such as Microsoft's Network Neighborhood.

While the invention has been described with reference to the aforementioned specification, the descriptions and illustrations of the embodiments herein are not meant to be construed in a limiting sense. It shall be understood that the invention is not limited to the specific depictions, configurations or relative proportions set forth herein which depend upon a variety of conditions and variables. Various modifications in form and detail of the embodiments of the invention, as well as other variations of the invention may be made upon reference to the present disclosure.

1. A method of configuring a tunnel connection between a first gateway and a second gateway, the method comprising:
completing configuration of the tunnel connection at the first gateway in response to a user request;
at the second gateway, receiving a request from the user to configure the second gateway;
at the second gateway, receiving an identification of the first gateway from the user;
sending a request for configuration information from the second gateway to the first gateway;
the first gateway authenticating the second gateway based on information received from the second gateway;
the second gateway sending configuration information to the first gateway; and
automatically configuring the second gateway, based on the configuration information received from the first gateway.

2. The method of claim 1, including:
the second gateway sending a hardware address of the second gateway to the first gateway; and
wherein authenticating the second gateway is based on the hardware address.

3. The method of claim 2, wherein the authenticating comprises determining whether the hardware address is within a particular range of addresses.

4. The method of claim 2, wherein the authenticating comprises testing the hardware address using a lookup table.

5. The method of claim 2, wherein the authenticating comprises determining whether the hardware address is one associated with a particular vendor.

6. The method of claim 1, including receiving tunnel policy information from a user for configuration of the first gateway.

7. The method of claim 1, including presenting the user with default suggestions for configuration of the first gateway.

8. The method of claim 1, wherein the identification of the first gateway received from the user includes an address of the first gateway.

9. The method of claim 1, wherein the identification of the first gateway received from the user comprises an IP address.

10. The method of claim 1, wherein the identification of the first gateway received from the user comprises an FQDN or static IP address.

11. A method of configuring a IPSec tunnel connection between a first gateway and a second gateway, the method comprising:
accommodating a remote user login at the first gateway;
receiving selection or entry of configuration information from the user at the first gateway;
completing configuration of the IPSec tunnel connection at the first gateway in response to a user request;
accommodating a remote user login at the second gateway;
at the second gateway, receiving a request from the user to configure the second gateway;
at the second gateway, receiving a static IP address or FQDN of the first gateway from the user;
sending a request for configuration information from the second gateway to the first gateway;
the first gateway authenticating the second gateway based on an address of the second gateway received from the second gateway;
if the authentication is successful, the second gateway sending configuration information to the first gateway; and
automatically configuring the IPSec tunnel connection on the second gateway, based on the configuration information received from the first gateway.

12. The method of claim 11, including presenting the user with suggested configuration information for configuration of the first gateway including an authentication algorithm.

13. The method of claim 11, including presenting the user with suggested configuration information for configuration of the first gateway including a security association (SA) lifetime.

14. The method of claim 11, including presenting the user with suggested configuration information for configuration of the first gateway including a security association (SA) tunnel size.

15. The method of claim 11, including presenting the user with suggested configuration information for configuration of the first gateway including authentication mode.

16. The method of claim 11, including presenting the user with suggested configuration information for configuration of the first gateway including traffic selection mode.

17. The method of claim 11, including the second gateway sending the first gateway an acceptance message after receipt of the configuration information from the first gateway.

18. The method of claim 11, including the first gateway sending a ping to the second gateway.

19. The method of claim 11, including the second gateway sending the user an acknowledgement that the tunnel has been established after receipt of a ping message from the first gateway.

20. A network system including:
a first gateway;
a second gateway,
logic to establish a tunnel connection, including
logic that completes configuration of the tunnel connection at the first gateway in response to a user request;
logic in the second gateway that receives a request from the user to configure the second gateway;
logic in the second gateway receives an identification of the first gateway from the user;
logic that sends a request for configuration information from the second gateway to the first gateway;
logic in the first gateway that authenticates the second gateway based on information received from the second gateway;
logic in the second gateway that sends configuration information to the first gateway; and
logic that automatically configures the second gateway, based on the configuration information received from the first gateway.

21. The network system of claim 20, including:
logic in the second gateway that sends a hardware address of the second gateway to the first gateway; and
wherein authenticating the second gateway is based on the hardware address.

22. The network system of claim 21, wherein the authenticating comprises determining whether the hardware address is one associated with a particular vendor.

23. The network system of claim 20, including logic that presents the user with default suggestions for configuration of the first gateway.

24. A network system comprising:
a first local network including a plurality of hosts and a first gateway;
a second local network including a second plurality of hosts and a second gateway;
logic to establish an IPSec tunnel connection between the first gateway and the second gateway, including
logic on the first gateway that accommodates a remote user login;
logic that receives selection or entry of configuration information from the user at the first gateway;
logic that completes configuration of the IPSec tunnel connection at the first gateway in response to a user request;
logic on the second gateway that accommodates a remote user login;
logic on the second gateway that receives a request from the user to configure the second gateway;
logic on the second gateway that receives a reference to the first gateway;
logic that sends a request for configuration information from the second gateway to the first gateway;
logic that authenticates the second gateway based on an address of the second gateway;
logic on the second gateway that sends configuration information to the first gateway; and
logic that automatically configures the IPSec tunnel connection on the second gateway, based on the configuration information received from the first gateway.

25. The network system of claim 24, including logic that presents the user with suggested configuration information for configuration of the first gateway including authentication algorithm.

26. The network system of claim 24, including a graphical user interface for receiving the configuration information from the user.

27. A computer program for configuring an IPSec tunnel between a first gateway and a second gateway, computer program comprising:
computer-readable code, the computer-readable code including,
HTML code;
means on the first gateway for accommodating a remote user login;
means for receiving selection or entry of configuration information from the user at the first gateway;
means for completing configuration of the IPSec tunnel connection at the first gateway in response to a user request;
means for accommodating a remote user login on the second gateway;
means for receiving a request from the user to configure the second gateway;
means on the second gateway for receiving a reference to the first gateway;
means for sending a request for configuration information from the second gateway to the first gateway;
means for authenticating the second gateway based on an address of the second gateway;
means on the first gateway for sending configuration information to the second gateway; and
means for automatically configuring the IPSec tunnel connection on the second gateway, based on the configuration information received from the first gateway.

28. A computer program for configuring an IPSec tunnel between a first gateway and a second gateway, computer program comprising:
computer-readable code, the computer-readable code including,
HTML code;
code on the second gateway that accommodates a remote user login;
code on the second gateway that receives a request from the user to configure the second gateway;
code on the second gateway that receives a reference to the first gateway;
code that sends a request for configuration information from the second gateway to the first gateway;
code that authenticates the second gateway based on an address of the second gateway;
code that sends configuration information to the first gateway; and
code that automatically configures the IPSec tunnel connection on the second gateway, based on the configuration information received from the first gateway.

29. The computer program of claim 28, the computer-readable code including
code that accommodates a remote user login on the first gateway;
code that receives selection or entry of configuration information from the user at the first gateway; and
code that completes configuration of the IPSec tunnel connection at the first gateway in response to a user request.

30. A business method comprising:
providing configuration software for configuring an IPSec tunnel connection between a first gateway and a second gateway, the configuration software including code that
receives a request from the user to configure the second gateway;
receives an identification of the first gateway from the user;
causes the second gateway to send a request for configuration information to the first gateway;
determines whether the second gateway is within a particular set of gateways based on a test; and
if the test is passed, causes the second gateway to send configuration information to the first gateway.

31. The business method claim 30, wherein the test identifies gateways provided by a single vendor.

32. The business method of claim 30, wherein the test identifies gateways provided by a selected plurality of vendors.

33. The business method of claim 30, wherein the test uses a lookup table to determine whether the address of the second gateway is an address of a gateway provided by an approved vendor.

34. The business method of claim 30, wherein the test determines whether a MAC address of the second gateway is a MAC address of a particular set of gateways.

35. The business method of claim 30, including providing gateways having hardware addresses capable of identification by the test.

36. The business method of claim 30, the configuration software including code that automatically configures the IPSec tunnel connection on the second gateway, based on the configuration information received from the first gateway.

37. The business method of claim 30, the configuration software including code that presents the user with suggested configuration information for configuration of the first gateway.
